(19) United States
(12) Patent Application Publication
(10) Pub. No.: US 2011/0225353 A1
(43) Pub. Date: Sep. 15, 2011

(54) REDUNDANT ARRAY OF INDEPENDENT DISKS (RAID) WRITE CACHE SUB-ASSEMBLY

(76) Inventors: Robert C Elliott, Houston, TX (US); Joseph E. Foster, Houston, TX (US); Siamak Tavallaei, Houston, TX (US)

(21) Appl. No.: 13/126,141

(22) PCT Filed: Oct. 30, 2008
(86) PCT No.: PCT/US08/81700

§ 371 Date: Apr. 26, 2011

(51) Int. Cl. G06F 12/00; G06F 12/08

(52) U.S. Cl. 711/103; 711/113; 711/105; 711/E12.008; 711/E12.019

(57) ABSTRACT

In at least some embodiments, a computing system includes a processor and a communication bus external to the processor. The computing system also includes a Redundant Array of Independent Disks (RAID) write cache sub-assembly coupled to the communication bus, the RAID write cache sub-assembly having non-volatile memory.

### BACKGROUND

Redundant Array of Independent Disks (RAID) technology combines multiple small, inexpensive disk drives into an array which yields performance exceeding that of one large and expensive disk drive. RAID provides benefits such as redundancy, lower latency, higher bandwidth, and data recoverability. RAID arrays appear to a computer to be one or more logical storage units or virtual disk drives.

There are two existing approaches to RAID: hardware-based RAID and software-based RAID. Hardware-based RAID manages drives independently from the host and presents one or more virtual disks to the host. In general, hardware-based RAID employs a RAID controller card that interfaces between the disk drives and the host. The benefits of hardware-based RAID include: minimizing host processor overhead, minimizing host system memory overhead, and providing a non-volatile RAID write cache. However, hardware-based RAID represents an undesirable expense to many consumers.

Software-based RAID implements the various RAID levels in the host. Software-based RAID is inexpensive and can provide high performance. However, it requires host processor and system memory overhead. Further, since software-based RAID relies on volatile system memory, data may be lost if a write transaction is interrupted (e.g., by power failure) before completing.

### BRIEF DESCRIPTION OF THE DRAWINGS

For a detailed description of exemplary embodiments of the invention, reference will now be made to the accompanying drawings in which:

FIG. 1 illustrates a Redundant Array of Independent Disks (RAID) system in accordance with embodiments;

FIG. 2 illustrates a computer system in accordance with embodiments;

FIGS. 3A and 3B illustrate RAID write cache cards or sub-assemblies in accordance with embodiments; and

FIG. 4 shows a method in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless connection. Thus, if a first device couples to a second device, that connection may be through a direct connection, through an indirect connection via other devices and connections, through an optical connection, or through a wireless connection. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

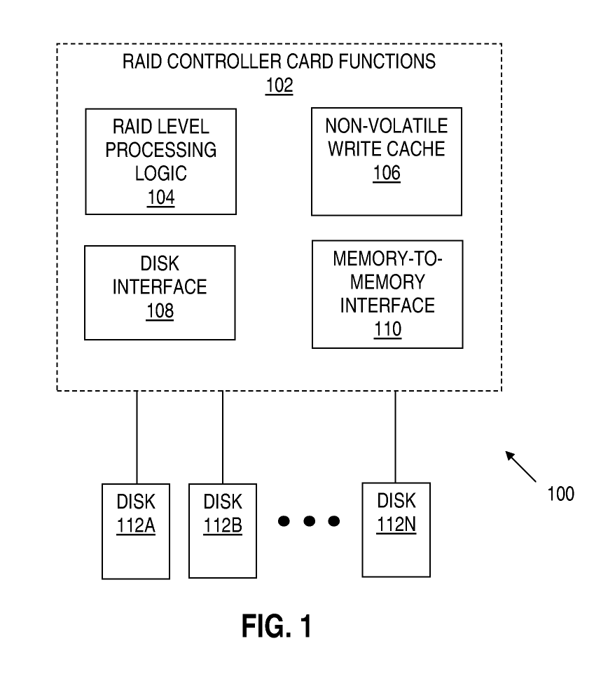

Embodiments of the disclosure provide Redundant Array of Independent Disks (RAID) functionality without a RAID controller card. In at least some embodiments, software-based RAID is enhanced by providing a non-volatile RAID write cache on a peripheral communication bus (e.g., a Peripheral Component Interconnect Express (PCIe) bus). FIG. 1 illustrates a RAID system 100 in accordance with various embodiments. As shown, the RAID system 100 provides RAID controller card functions 102 to support a plurality of disks 112A-112N. The RAID controller card functions 102 include, but are not limited to, RAID level processing logic 104, a non-volatile write cache 106, a disk interface 108, and a memory-to-memory interface 110. Rather than implement a traditional RAID controller card, embodiments distribute the functions 102 to other components of a computer system as described herein.

In accordance with embodiments, the functions 102 support known RAID operations such as striping and data mirroring. Striping involves dividing data into uniformly-sized blocks and spreading the blocks over at least some of the disks 112A-112N. If read/write heads of the disks 112A-112N are active simultaneously, striping can improve the speed of data transfers. In general, data mirroring provides data redundancy. RAID-0, RAID-1, RAID-5, and RAID-6 are examples of data redundancy schemes.

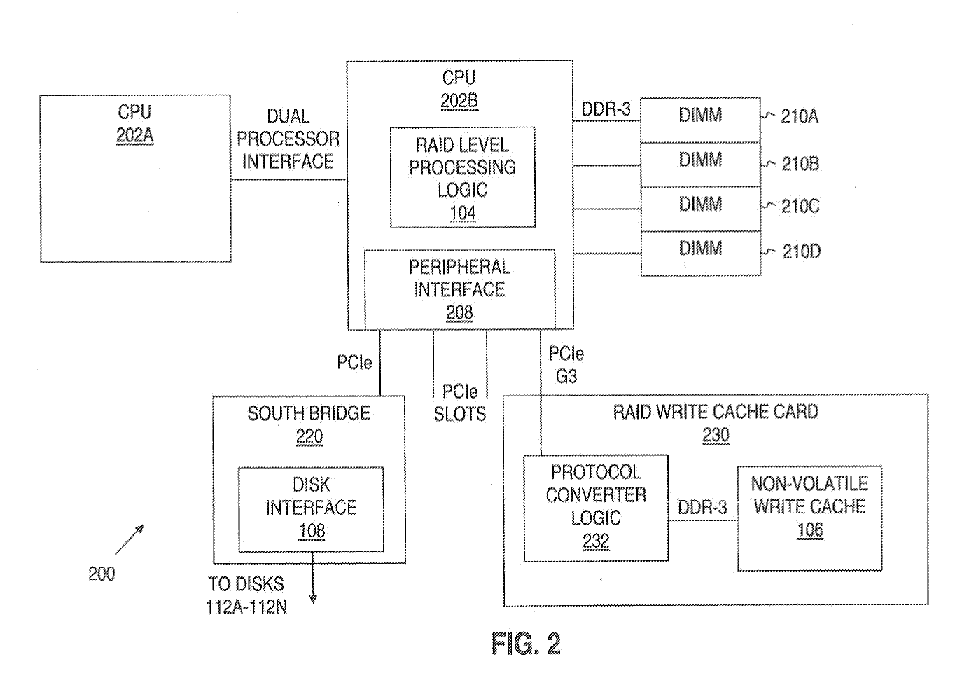

FIG. 2 illustrates a computer system 200 in accordance with embodiments. As shown, the computer system 200 comprises CPUs 202A and 202B, which are connected via a dual processor interface. In alternative embodiments, additional or fewer CPUs may be implemented. Regardless of the number of CPUs, at least one of the CPUs (e.g., CPU 202B) comprises RAID level processing logic 104 to support the RAID operations described previously. The RAID level processing logic 104 may comprise hardware, firmware and/or software. In at least some embodiments, the RAID level processing logic 104 corresponds to software-based RAID functions.

The CPU 202B communicates with a plurality of Dual Inline Memory Modules (DIMMs) 210A-210D via a memory module protocol such as Double Data Rate 3 (DDR-3). Alternatively, other memory module protocols may be used. As shown, the CPU 202B also comprises a peripheral interface 208, which may be a Peripheral Component Interconnect Express (PCIe) interface. In such a case, communications between the peripheral interface 208 and various internal or external components of the computer system 200 are based on the PCIe protocol.

In some embodiments, the peripheral interface 208 couples to a South Bridge 220 having the disk interface 108. In such embodiments, communications between the peripheral interface 208 and the South Bridge 220 may be based on the PCIe protocol or other protocols. Further, communications between the South Bridge 220 and disks 112A-112N may be based on the Serial Attached SCSI (SAS) protocol, the Serial ATA (SATA) protocol, the Universal Serial Bus (USB) protocol, or another communication protocol implemented by the disk interface 108.

The peripheral interface 208 also couples to a RAID write cache card or sub-assembly 230 (i.e., the components may assembled on a card or other location). As shown, the RAID write cache card or sub-assembly 230 comprises protocol converter logic 232 coupled to the non-volatile write cache 106. The protocol converter logic 232 converts communication bus data received from the peripheral interface 208 to memory module data for storage in the non-volatile write cache 106. As an example, the protocol converter logic 232 may convert PCIe Generation 3 data to DDR-3 data and vice versa. In accordance with embodiments, the non-volatile write cache 106 comprises Dynamic Random Access Memory (DRAM), a power source (e.g., a battery) and, in some embodiments, a Flash memory.

Write caching as provided by the non-volatile write cache 106 is based on the principle that writing to cache is faster than writing to disk and is a cost-effective way to improve I/O performance of a RAID system (e.g., RAID system 100). In a write transaction, write data is written to cache and the write transaction is acknowledged as “complete” to the host that issued the write. Some time later, the cached write may be written or flushed to disk. When the host receives the “complete” acknowledgement, it is assumed that the data is permanently stored on disk. If I/O components lose power, write caching can cause incorrect data to be delivered to applications and can corrupt databases when power is restored. To ameliorate or eliminate such problems, the non-volatile write cache 106 stores information that can be used to complete writes that were in progress when the computer system 200 recovers from a crash or power loss.

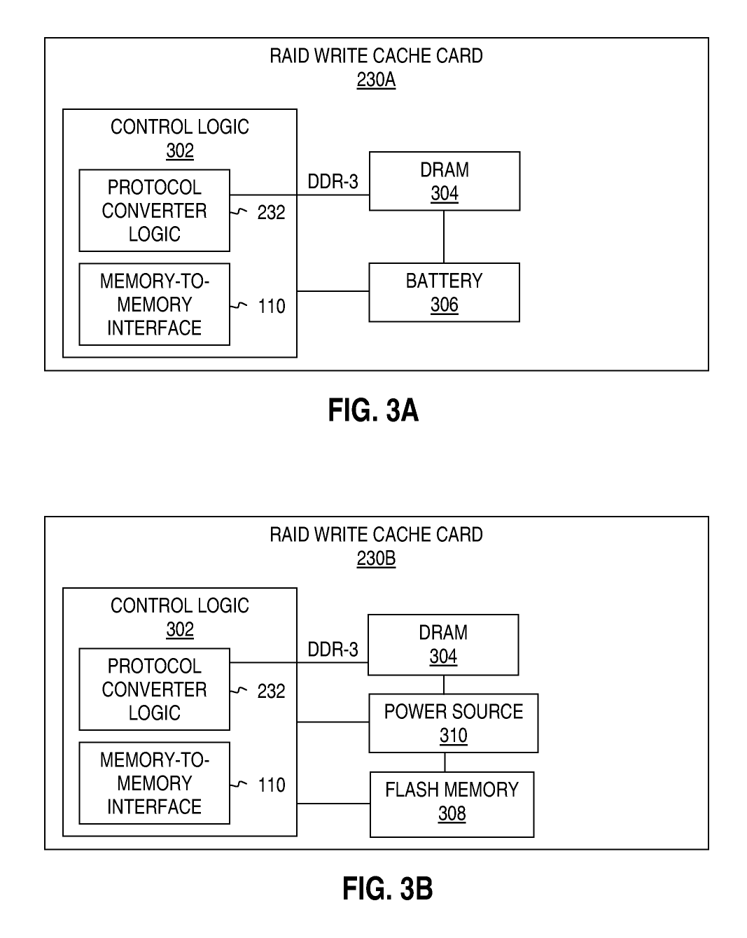

FIG. 3A illustrates a RAID write cache card or sub-assembly 230A in accordance with various embodiments. As shown, the RAID write cache card or sub-assembly 230A comprises control logic 302 (e.g., an application specific integrated circuit (ASIC) or other semiconductor device) having the protocol converter logic 232 and the memory-to-memory interface 110. In some embodiments, the control logic 302 corresponds to a field programmable gate array (FPGA). Also, the memory-to-memory interface 110 may correspond to a Direct Memory Access (DMA) interface. In some embodiments, the CPU 202B comprises at least some of the memory-to-memory interface 110 or provides an additional or alternative memory-to-memory interface.

The RAID write cache card or sub-assembly 230A also comprises DRAM 304 and a battery 306 that provides power to the control logic 302 and/or the DRAM 304 even if the computer system 200 crashes or loses power. Together, the DRAM 304 and the battery 308 represent a battery-backed DRAM or, more generally, some non-volatile storage. When the computer system 200 has recovered, information stored in the DRAM 304 can be used to finalize RAID writes that were in process when the computer system 200 crashed or lost power.

FIG. 3B illustrates a RAID write cache card or sub-assembly 230B in accordance with embodiments. As shown, the RAID write cache card or sub-assembly 230B comprises control logic 302 having the protocol converter logic 232 and the memory-to-memory interface 110 (e.g., a DMA interface). In some embodiments, the CPU 202B comprises at least some of the memory-to-memory interface 110 or provides an additional or alternative memory-to-memory interface 110.

The RAID write cache card or sub-assembly 230B also comprises DRAM 304, a Flash memory 308 and a power source 310 (e.g., a battery or capacitor). The power source 310 provides power to the control logic 302, the DRAM 304, and/or the Flash memory 308 even if the computer system 200 crashes or loses power. Together, the DRAM 304, the Flash memory 308 and the power source 310 represent non-volatile storage. In some embodiments, upon detection of a computer system 200 crash or power loss, the power source 310 enables data to be transferred from the DRAM 304 to the Flash memory 308 via the memory-to-memory interface 110. When the computer system 200 has recovered, data is transferred from the Flash memory 308 back to the DRAM 304 and the information stored in the DRAM 304 can be used to finalize writes that were in process when the computer system 200 crashed or lost power.

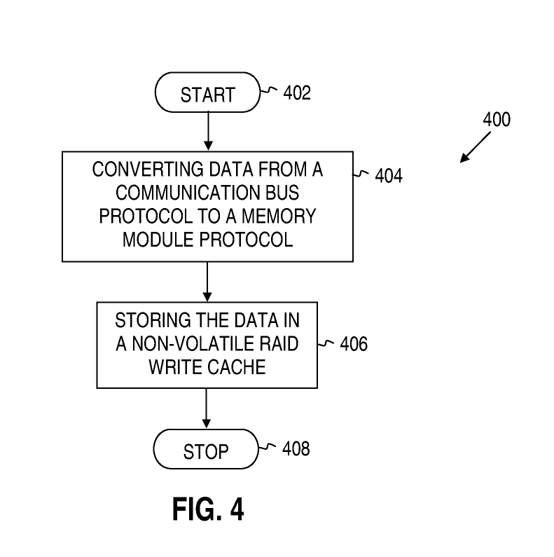

FIG. 4 illustrates a method 400 in accordance with embodiments. As shown, the method 400 starts at block 402 and continues by converting data from a communication bus protocol to a memory module protocol (block 404). The data is stored in a non-volatile RAID write cache (block 406) and the method 400 ends at block 408. In at least some embodiments, the method 400 may also include performing memory-to-memory operations for the non-volatile RAID write cache. As an example, the method 400 may involve determining when a computing system crashes or loses power and, in response, transferring data from DRAM to a Flash memory. The DRAM and the Flash memory may be part of a RAID write cache card or sub-assembly.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor;
a disk interface coupled to the processor;
a communication bus external to the processor; and
a Redundant Array of Independent Disks (RAID) write cache sub-assembly coupled to the communication bus, the RAID write cache sub-assembly having non-volatile storage.

2. The computer system of claim 1 wherein the non-volatile storage comprises a battery-backed Dynamic Random Access Memory (DRAM).

3. The computer system of claim 1 wherein the non-volatile storage comprises Dynamic Random Access Memory (DRAM), a power source and Flash memory.

4. The computer system of claim 3 wherein the RAID write cache sub-assembly further comprises a battery and Direct Memory Access (DMA) logic for transferring data from DRAM to a Flash memory when the computing system loses power.

5. The computer system of claim 1 further comprising a chipset associated with the processor, wherein the chipset comprises logic for communicating with RAID disk drives.

6. The computer system of claim 1 wherein the processor performs at least some RAID controller operations.

7. The computer system of claim 1 wherein the RAID write cache sub-assembly further comprises logic for converting data from a protocol of the communication bus to a Dynamic Random Access Memory (DRAM) protocol and vice versa.

8. The computer system of claim 1 wherein the communication bus corresponds to a PCI-Express bus and wherein the RAID write cache sub-assembly comprises a PCI-Express compatible card.

9. A Redundant Array of Independent Disks (RAID) write cache sub-assembly, comprising:
logic for converting data between a communication bus protocol and a memory module protocol; and
a non-volatile RAID write cache coupled to the logic.

10. The RAID write cache sub-assembly of claim 9 wherein the non-volatile RAID write cache comprises a battery-backed Dynamic Random Access Memory (DRAM).

11. The RAID write cache sub-assembly of claim 9 wherein the non-volatile RAID write cache comprises a Flash memory and a power source.

12. The RAID write cache sub-assembly of claim 9 further comprising a Direct Memory Access (DMA) interface for performing memory-to-memory operations for the battery-backed RAID write cache.

13. A method for a Redundant Array of Independent Disks (RAID) write cache sub-assembly, comprising:
converting data from a communication bus protocol to a memory module protocol; and
storing the data in a non-volatile RAID write cache.

14. The method of claim 13 further comprising performing memory-to-memory operations for the non-volatile RAID write cache.

15. The method of claim 13 further comprising determining when a computing system loses power and, in response, transferring data from Dynamic Random Access Memory (DRAM) to a Flash memory.
